(19) United States
(12) Patent Application Publication
(10) Pub. No.: US 2010/0060667 A1
(43) Pub. Date: Mar. 11, 2010

(54) ANGULARLY DEPENDENT DISPLAY OPTIMIZED FOR MULTIPLE VIEWING ANGLES

(75) Inventors: Cheng CHEN, Cupertino, CA (US); Wei Chen, Palo Alto, CA (US); Victor Hao-En Yin, Cupertino, CA (US); John Z. Zhong, Cupertino, CA (US)

Correspondence Address: APPLE C/O MOFO SD, 12531 HIGH BLUFF DRIVE #100, SAN DIEGO, CA, 92130-2040, US

(73) Assignee: Apple Inc., Cupertino, CA (US)

(21) Appl. No.: 12/208,290

(22) Filed: Sep. 10, 2008

(51) Int. Cl. G09G 5/10

(52) U.S. Cl. 345/690

(57) ABSTRACT

Methods and apparatus for providing optimized gamma settings for each of a plurality of viewing angles and/or device orientations. In certain types of display devices, off-axis viewing leads to contrast degradation and/or color aberrations in a perceived image, as luminance values depend on the angle at which the output is viewed. By remapping grayscale and/or color values to new output voltages, an image can be presented at an optimized luminance level when viewed from any specific angle. In some embodiments, the display device comprises an inclination sensor adapted to sense device rotation about at least one axis. Display parameter optimization logic reads data from the inclination sensor and automatically adjusts the display to an optimized gamma setting.

### FIELD OF THE INVENTION

The present invention relates generally to the field of display devices. More particularly, the present invention is directed in one exemplary aspect to providing an optimized display setting for each of a plurality of viewing angles and/or device orientations.

### DESCRIPTION OF RELATED TECHNOLOGY

Many conventional liquid crystal display devices assume that the user is viewing the display at a normal axis (i.e., at 90° relative to the axis of the display). When viewing the display from a different angle, the perceived image often appears distorted because of the nature of the display technology. In most cases, such “off-axis” viewing leads to contrast degradation and/or color aberrations in the perceived image.

An example of off-axis viewing is shown in FIG. 1a and FIG. 1c. FIGS. 1a-1c depict simulations of the appearance of an image presented by a twisted nematic display when viewed at 45° from the left (FIG. 1a), at the normal axis (FIG. 1b), and at 45° degrees from the right (FIG. 1c). As FIGS. 1a and 1c both demonstrate, off-axis viewing results in degradation of contrast and an associated decline in image quality.

FIG. 2 is a viewing angle plot illustrating various angular limitations of a conventional twisted nematic display device. Tilt angle is represented by concentric octagons each demarcating 10° increments. The dark line represents the maximum viewing angle before dark gray scale inversion occurs; the dashed line represents the maximum viewing angle before bright gray scale inversion occurs. As shown by the figure, dark gray scale inversion occurs at approximately half of the viewing cone.

Such limitations are not suitable for display devices, particularly handheld devices that are expected to tilt, shift, or otherwise change position many times in the course of a day. Moreover, since inclination sensing is expected to become a prevalent means of providing input to various software applications in the immediate future (for example, in gaming applications), it is unreasonable to continue requiring the user to assume the same vantage point every time the device is in use.

While certain liquid crystal display technologies presently offer ultra-wide viewing angles (e.g., in-plane switching and multi-domain vertical alignment devices), these technologies often suffer from lower light transmittance, lower yield, and higher prices compared to conventional twisted nematic technologies. Additionally, many portable designs simply cannot afford the power budget or the premium price associated with utilizing these technologies.

What is needed is a means or mechanism for correcting the effects of angular dependence in conventional liquid crystal display technologies. More specifically, what is needed is a means or mechanism for presenting graphical data at acceptable luminance levels for each of a plurality of display vantage points. Ideally, the system would be able to detect its orientation automatically and select an appropriate display setting in real time.

### SUMMARY OF THE INVENTION

The present invention satisfies the foregoing needs by disclosing, inter alia, methods and apparatus adapted to present graphical data at acceptable luminance levels for each of a plurality of display vantage points. In some embodiments, the orientation is detected automatically, and display is adjusted in real time.

In a first aspect of the invention, a method is disclosed. In one embodiment, the method comprises: determining a plurality of orientation profiles for a display device; and determining at least one set of parameters adapted to achieve an optimized gamma setting for each orientation profile of the plurality.

In a second aspect of the invention, an apparatus is disclosed. In one embodiment, the apparatus comprises: a first module adapted to determine a set of parameters for obtaining a target gamma setting for each of a plurality of display orientations; a second module adapted to determine a current display orientation; and a third module adapted to apply the set of parameters corresponding to the current display orientation.

In a third aspect of the invention, a computer readable medium is disclosed. In one embodiment, the computer readable medium stores computer executable instructions which, when executed by a computer, perform a process comprising: receiving positional data associated with a device comprising a display; determining an optimized display parameter based at least in part upon the positional data; and driving the display according to the optimized display parameter.

In a fourth aspect of the invention, a method is disclosed. In one embodiment, the method comprises: receiving data comprising a bit value and an orientation of a display; and determining a voltage based at least in part upon the bit value and the orientation of the display.

### BRIEF DESCRIPTION OF THE DRAWINGS

FIG. 1a is a simulation of the appearance of an image presented by a twisted nematic display when viewed 45° left of the normal axis of view.

FIG. 1b is a simulation of the appearance of an image presented by a twisted nematic display when viewed at the normal axis of view.

FIG. 1c is a simulation of the appearance of an image presented by a twisted nematic display when viewed 45° right of the normal axis of view.

FIG. 2 is a viewing angle plot illustrating the angular limitations of a twisted nematic display device.

FIG. 3a is a block diagram illustrating how liquid crystal molecules in an electrically-controlled birefringent display respond to a generated electric field.

FIG. 3b is a block diagram illustrating how liquid crystal molecules in a twisted nematic display respond to a generated electric field.

FIG. 3c is a block diagram illustrating how liquid crystal molecules in a super-twisted nematic display respond to a generated electric field.

FIG. 4 is an exemplary graph illustrating luminance as a function of grayscale.

FIG. 5a is a graphical representation of a display device when viewed at the normal axis.

FIG. 5b is a graphical representation of a display device when viewed at an angle measured relative to the normal axis.

FIG. 6 is a graph illustrating a set of electro-optical curves associated with an angularly dependent viewing device.

FIG. 7 is a flow diagram illustrating a method of providing optimized display parameters according to one embodiment of the present invention.

FIG. 8 is a flow diagram illustrating a method of accomplishing gamma voltage correction according to another embodiment of the present invention.

FIG. 9 is an angular representation of a display device orientation according to one embodiment of the present invention.

FIG. 10 is a three-dimensional lookup table for use with the angular representation depicted by FIG. 9.

FIG. 11 is a block diagram illustrating a device adapted to present graphical data at designated luminance levels for each of a plurality of display vantage points according to one embodiment of the present invention.

FIG. 12 is a graph illustrating electro-optical response curves optimized for viewing a twisted nematic display at different angles according to one embodiment of the present invention.

FIG. 13 is a graph illustrating a transmittance curve in a horizontal direction when a first set of display parameters is used to drive a twisted nematic display.

FIG. 14 is a graph illustrating a transmittance curve in a horizontal direction when a second set of display parameters is used to drive a twisted nematic display.

FIG. 15a is an iso-contrast plot of a twisted nematic display operating at a first set of display parameters.

FIG. 15b is an iso-contrast plot of a twisted nematic display operating at a second set of display parameters.

FIG. 16a is a simulation of the appearance of an image presented by a twisted nematic display optimized for view 45° left of the normal axis as viewed 45° left of the normal axis.

FIG. 16b is a simulation of the appearance of an image presented by a twisted nematic display optimized for view 45° left of the normal axis as viewed at the normal axis.

FIG. 16c is a simulation of the appearance of an image presented by a twisted nematic display optimized for view 45° left of the normal axis as viewed 45° right of the normal axis.

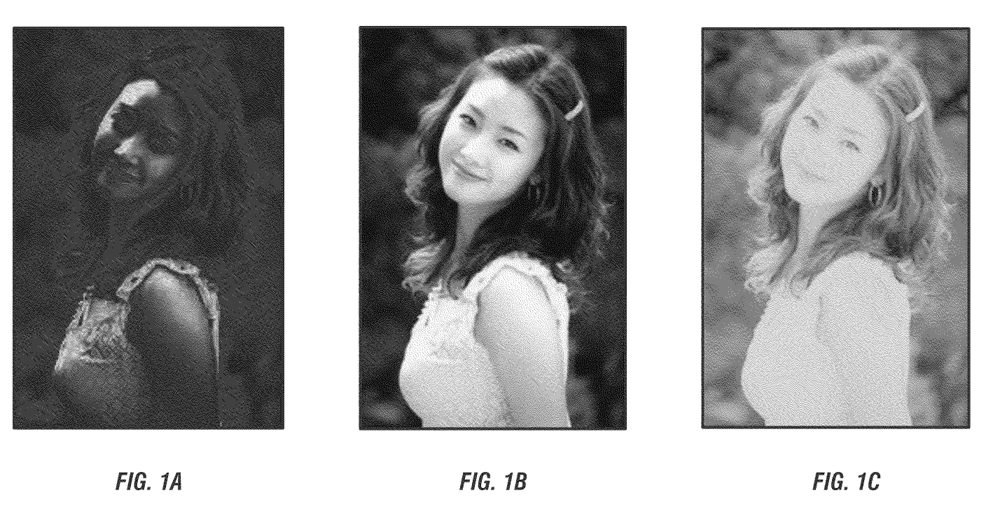

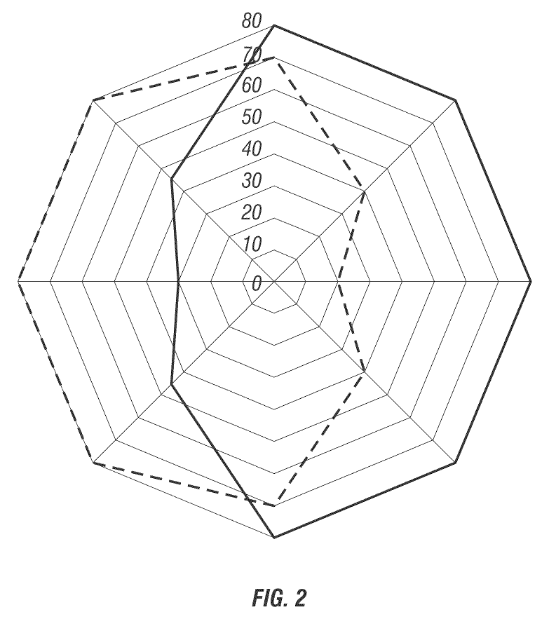

### DETAILED DESCRIPTION OF THE EXEMPLARY EMBODIMENTS

In the following description of exemplary embodiments, reference is made to the accompanying drawings which form a part hereof, and in which it is shown by way of illustration specific embodiments in which the invention may be practiced. It is to be understood that other embodiments may be utilized and structural changes may be made without departing from the scope of the present invention.

As used herein, the term “application” includes without limitation any unit of executable software that implements a specific functionality or theme. The unit of executable software may run in a predetermined environment; for example, a downloadable Java Xlet™ which runs within the JavaTV™ environment.

As used herein, the terms “computer program” and “software” include without limitation any sequence of human or machine cognizable steps that are adapted to be processed by a computer. Such may be rendered in any programming language or environment including, for example, C/C++, Fortran, COBOL, PASCAL, Perl, Prolog, assembly language, scripting languages, markup languages (e.g., HTML, SGML, XML, VoXML), functional languages (e.g., APL, Erlang, Haskell, Lisp, ML, F# and Scheme), as well as object-oriented environments such as the Common Object Request Broker Architecture (CORBA), Java™ (including J2ME, Java Beans, etc.).

As used herein, the term “display” includes any type of device, structure, or apparatus adapted to generate an output such that the perceived output may be affected by the angle at which the output is viewed. The term “display” includes all types of liquid crystal display devices, including, for example, thin film transistor displays, twisted nematic displays, super-twisted nematic displays, electrically controlled birefringent displays, optically compensated bend displays, in-plane switching displays, vertical alignment displays, surface-stabilized cholesteric displays, as well as displays capable of multi-mode operation.

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, “flash” memory (e.g., NAND/NOR), and PSRAM.

As used herein, the term “module” refers to any type of software, firmware, hardware, or combination thereof that is designed to perform a desired function.

As used herein, the terms “processor,” “microprocessor,” and “digital processor” refer to all types of digital processing devices including, without limitation, digital signal processors (DSPs), reduced instruction set computers (RISC), general-purpose (CISC) processors, microprocessors, gate arrays (e.g., FPGAs), programmable logic devices (PLDs), reconfigurable compute fabrics (RCFs), array processors, and application-specific integrated circuits (ASICs). Such processors may be contained on a single unitary IC die, or distributed across multiple components.

Liquid crystal displays are typically thin, flat displays made up of a number of color or monochrome pixels arranged in front of a light source. Each pixel of a liquid crystal display consists of a layer of molecules aligned between two transparent electrodes. The surfaces of the electrodes that are in contact with the liquid crystal material align the liquid crystal molecules in a particular direction.

The particular alignment of the liquid crystal molecules depends in part upon the relative orientation of the liquid crystal molecules at the adjoining surfaces. For example, when the surface alignment directions at the two electrodes are perpendicular to each other, the liquid crystal molecules assume a helical or twisted arrangement.

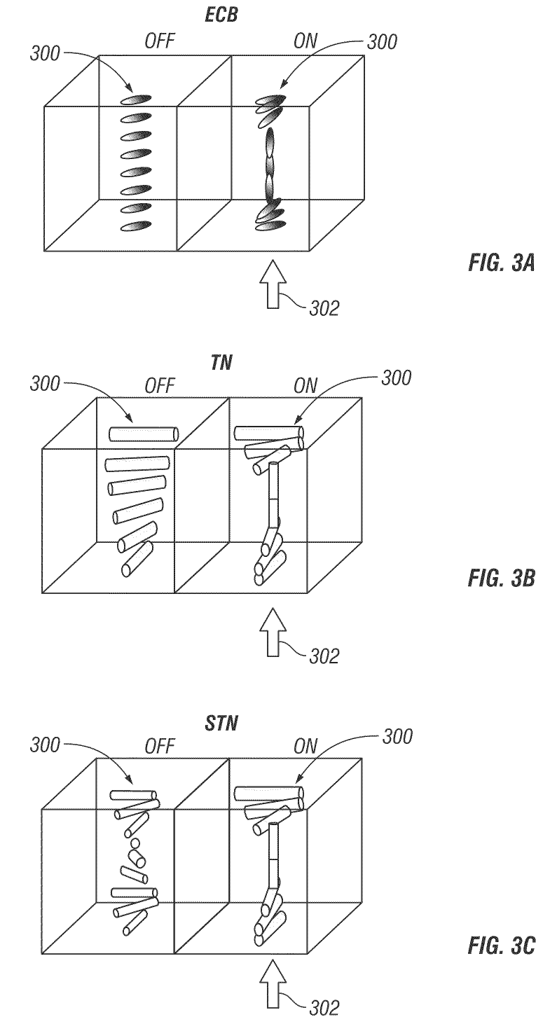

FIGS. 3a-3c are block diagrams illustrating how liquid crystal molecules in various types of displays 300 respond to a generated electric field 302. FIG. 3a depicts the response in an electrically-controlled birefringent display, FIG. 3b depicts the response in a twisted nematic display, and FIG. 3c depicts the response in a super-twisted nematic display.

The liquid crystal molecules rotate the polarization of incident light with respect to one or more filters, in effect acting as a shutter. When a voltage is applied across the electrodes, a torque acts to align the liquid crystal molecules 300 in a direction parallel to the electric field 302. The amount that the liquid crystal molecules rotate the polarization of incident light depends upon the voltage between the electrodes. Thus, by controlling the voltage applied across liquid crystal layers associated with each pixel, light can be allowed to pass through in varying amounts, thereby constituting different levels of gray (or in the case of color, in different levels of red, green, and blue).

The bit values associated with a given pixel map to an input voltage. In turn, the luminance of the displayed pixel depends upon the input voltage. In many types of display devices, luminance is a non-linear function of grayscale, and is often related to grayscale by the exponent gamma γ. The relationship between luminance and grayscale is known as a gamma curve.

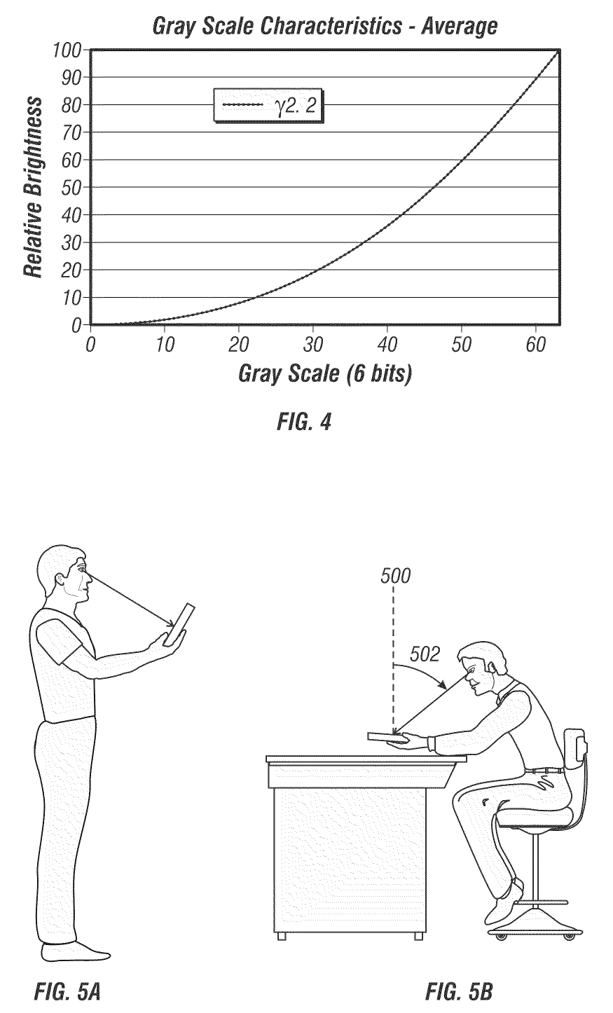

For example, FIG. 4 is a graph illustrating luminance as a function of grayscale when gamma γ is taken to be 2.2. As shown by the bend in the figure, the output luminance at a given grayscale value will often times be darker than the linear luminance grayscale equivalent. In order to achieve a luminance output which accurately reflects the image input, a correction function is calculated based upon the gamma value.

Note that the optimal luminance-grayscale function that accounts for the effects of gamma assumes angular independence with respect to a user's position of view. For example, prior art gamma correction functions optimize a display for viewing from the normal axis (i.e., when the user's view is 90° relative to the display axis). A normal axis viewing orientation is shown in FIG. 5a.

However, despite optimization at the normal axis, the display is not optimized for other viewing angles. For example, if the user views the same display at an angle 502 relative to the normal axis 500 (as can be seen in FIG. 5b), the user will perceive abnormal levels of gray in the image as well as contrast degradations. In color displays, off-axis viewing can also result in incorrect ratios of red, green, and blue in the perceived image.

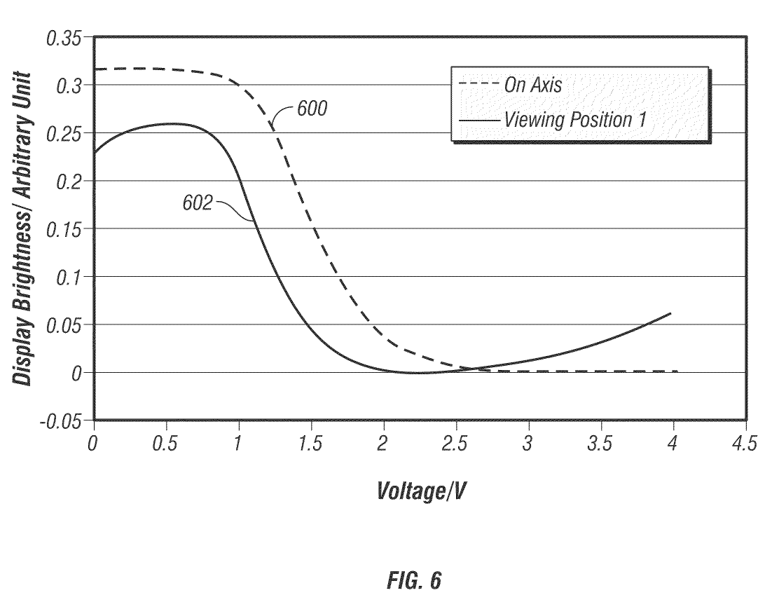

For instance, FIG. 6 is a graph illustrating a set of electro-optical curves associated with an angularly dependent viewing device. A first curve 600 illustrates a view taken from the normal axis, while a second curve 602 illustrates a view taken from an angle relative to the normal axis. As evidenced by the figure, a given voltage may yield a brightness level that varies according to the user's angle of view. Thus, in order to achieve an optimized set of display parameters, the user's angle of view needs to be taken into account.

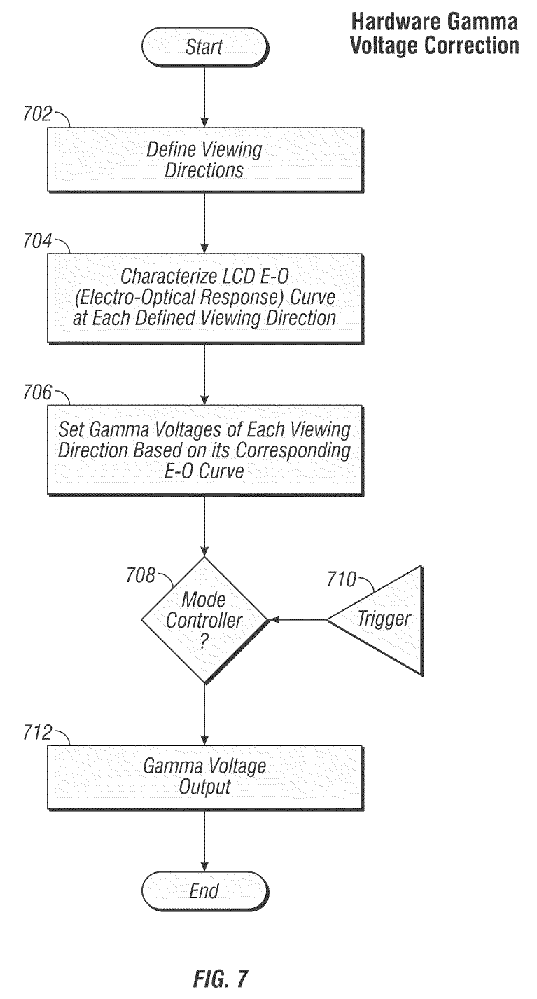

FIG. 7 is a flow diagram illustrating a method of providing optimized display parameters according to one embodiment of the present invention. In several embodiments described by the discussion that follows, a device orientation corresponds with a set of display parameters that are optimized for that particular orientation. By creating optimized display parameters for a plurality of different orientations, the adverse effects associated with angular dependency can be mitigated and/or eliminated.

At block 702, a set of viewing directions is defined. In some embodiments, the viewing directions are defined as an amount of rotation about at least one axis. For example, if a display device is tilted 20° with respect to the x-axis, and −40° with respect to the y-axis, both axis tilt values may together be used to represent a single viewing direction. In other embodiments, viewing direction is represented relative to the normal axis of display (i.e., as taken from the angle of the user's direct line of sight). Note that any representation, mathematical space, coordinate system or combination thereof may be used to indicate a viewing direction, including, for example, generalized coordinates, Cartesian coordinates, biangular coordinates, intrinsic coordinates, and/or polar coordinates (e.g., circular, spherical, or cylindrical coordinate systems).

Also note that in some embodiments, information about a third dimension is also recorded (e.g., varying levels of rotation about the z-axis). Information about the third dimension is useful in embodiments where multiple voltage functions map to a single viewing direction, particularly in those cases where separate voltage functions are utilized for different regions of a large display.

The amount of granularity present in the system may also vary according to several embodiments of the present invention. In some embodiments, viewing directions are defined in terms of ranges as opposed to a single point of presentation. For example, in an embodiment defining viewing directions in terms of angular offsets, a single display setting is used for ranges of angles (e.g., x-axis: 30°-40°, y-axis: 20°-25°). The defined ranges need not necessarily be uniform across the system. For example, when a small change in angle results in a large change in perceived output, a higher level of granularity (i.e. a smaller range) may be desired. Note that in some embodiments, the viewing direction comprises a range that is less than one degree with respect to at least one dimension.

The ranges may be predicated on any number of factors and/or performance criteria. For example, in certain embodiments involving a display device that can automatically detect changes in device or display inclination (as will be described in more detail below), slight movement of the device will often trigger display parameter optimization logic when the defined ranges are small. As a result of more frequent display parameter updates, system resources will be more frequently allocated to display parameter optimization logic. Note that in some embodiments, the frequency of inclination sensing as well as precision of the inclination sensor are independent from the frequency of updating the display parameter optimization logic.

The defined ranges may also be based upon acceptable levels of image degradation. For example, slight changes in angle may yield contrast and/or color issues that are hardly detectable or unnoticeable to the human eye. As such, the ranges may be defined progressively, discretely, or in an otherwise non-uniform manner according to various embodiments of the present invention. The ranges can therefore account for elasticity in a function relating angles of view with the amount of change required to display settings that are optimized for viewing the display at the normal axis.

The defined ranges may also be based upon trade-offs between local optimization and the size of an acceptable viewing cone. In other words, display settings can be modulated to service a wider range of viewing directions with an attendant drop in optimization. In several embodiments, a user is given control of the compensation level via one or more user interfaces. In some embodiments, compensation levels are implemented by storing a separate reference database for each compensation level selectable by the user.

At block 704, an electro-optical response curve is defined per each viewing direction (or alternatively, for each range of viewing directions). In some embodiments, the electro-optical response curve comprises a transmittance-voltage (T-V) curve that is a function of the gamma value.

In some embodiments, the transmittance-voltage curve for a given orientation or angle of view is a function of the transmittance-voltage curve optimized for viewing the display at the normal axis. For example, in some embodiments, a mathematical function is used to transform the curve optimized for normal axis viewing into a curve optimized for off-axis viewing. In one embodiment, a mathematical function modulates the curve based upon specific values associated with positional data (for example, device orientation data, angles of view, and/or other similar measurements). A shift or functional transformation of the curve optimized for normal axis viewing can therefore yield a curve optimized for off-axis viewing.

In some embodiments, one or more photometric sensors, light-sensitive detectors, and/or other measuring devices are used to measure luminance, intensity, and/or transmittance levels at various device orientations. Data supplied by the sensors are used to generate a curve optimized for off-axis viewing. In certain embodiments, the data comprise differences between the luminance levels detected at the measured axis when the display is optimized for normal axis viewing and expected luminance values. In one embodiment, a function is calculated based upon interpolation.

In some embodiments, a computer simulation of off-axis viewing is used to determine the appropriate transmittance-voltage settings for various angles of off-axis view. In one embodiment, accurate driving voltages for each grayscale or color value on the gamma curve are determined by testing a plurality of voltage settings for each grayscale or color value.

At block 706, the gamma voltages of each viewing direction are set based upon a corresponding electro-optical response curve. In certain embodiments, a function relating luminance to bit value (i.e. grayscale value or color value) as optimized for viewing from a certain axis is used as a basis for calculating the new voltage to be assigned to the bit value in a second function. In some embodiments, a ratio or functional dependency in the first function (e.g., voltage to transmittance, bit value to luminance, etc.), is used to determine the appropriate voltage for the bit value in the second function.

At block 708, the appropriate mode of operation is determined based upon one or more triggering events 710. In some embodiments, the mode of operation is determined based upon user input. For example, in one embodiment, a user toggles among a plurality of display parameter optimization functions based upon the user's perception of a test image. In other embodiments, a user inputs data indicating the user's position relative to the display device. For example, in one embodiment, the user positions an indicator on a graphical object representing a coordinate space. The display device interprets each indicator selection with a selected position, inclination, or vantage point (e.g., x=30°, y=−10°).

In other embodiments, the display device is adapted to automatically select an appropriate mode of operation based upon a set of sensory data. Automatic mode selection can be accomplished, for example, via one or more inclination sensors or other similar measuring devices housed within the display device (e.g., an accelerometer). In one embodiment, the inclination sensor detects the amount of rotation about at least one axis and provides the amount of rotation to display parameter optimization logic. Modes of operation are then triggered based upon the sensed data.

For example, assume that a handheld device is initially placed at rest upon a flat surface such as a counter or a tabletop and subsequently lifted off of the surface while being rotated about the x-axis by −90°. In some embodiments, an accelerometer will initially indicate that the device's orientation is: x-axis=0°, y-axis=0°. When the user subsequently lifts the device off of the surface, the accelerometer will indicate that the device's orientation is presently x-axis=−90′, y-axis=0°. The display parameter optimization logic selects the optimized gamma function corresponding to (−90, 0). Modes of operation are triggered based upon the frequency of updating display parameters.

In other embodiments, one or more light detection modules, cameras or photosensor arrays are adapted to detect the position and/or orientation of the display device. The light detection modules, cameras, or photosensor arrays may be attached to the device itself, housed within the device, or externally situated according to embodiments of the present invention. In some embodiments, face-detection technology is used to calculate the relative position and orientation of the device with respect to the user.

In several embodiments, the user can set a calibration baseline for automatic display parameter updates. For example, suppose that a user expects to be situated at an angle 10° smaller than the angle optimized for viewing (e.g., as derived from data generated by the inclination sensor). In various embodiments, the user provides the display device with the expected angle. In some embodiments, the user enters the expected angle directly into a user interface (e.g., x-axis=−10′). In other embodiments, the system derives the expected angle based upon the user's response to a test image generated at a plurality of display settings. Once the expected angle has been supplied to the system, the display parameter optimization logic applies an offset to the angle derived from the inclination sensor. Thus, as the device rotates, the user's vantage point relative to the angle of optimization is preserved.

In some embodiments, the calibration baseline may be determined by one or more light detection modules, cameras, or photosensor arrays. For example, a camera may be used to determine the default position and/or orientation of the device using face detection technology. In one embodiment, the position of the face relative to the device is used to determine an offset from the angle of optimization. The position and/or orientation of the device can then be determined in real-time as measured relative to the offset.

At block 712, the appropriate set of voltages is selected and then output. Voltage selection and/or modulation may be accomplished by any means, for example, via switches, resistor arrays, or other types of circuit arrangements. In some embodiments, a single set of voltages applies uniformly to all pixels and regions of the display. In other embodiments, different voltage sets apply to separate regions of a single display. Multiple voltage sets may be useful, for example, in large displays where a perceived pixel in one region of the display is expected to be viewed at an angle that is effectively different than the angle used for viewing a pixel in another region of the display.

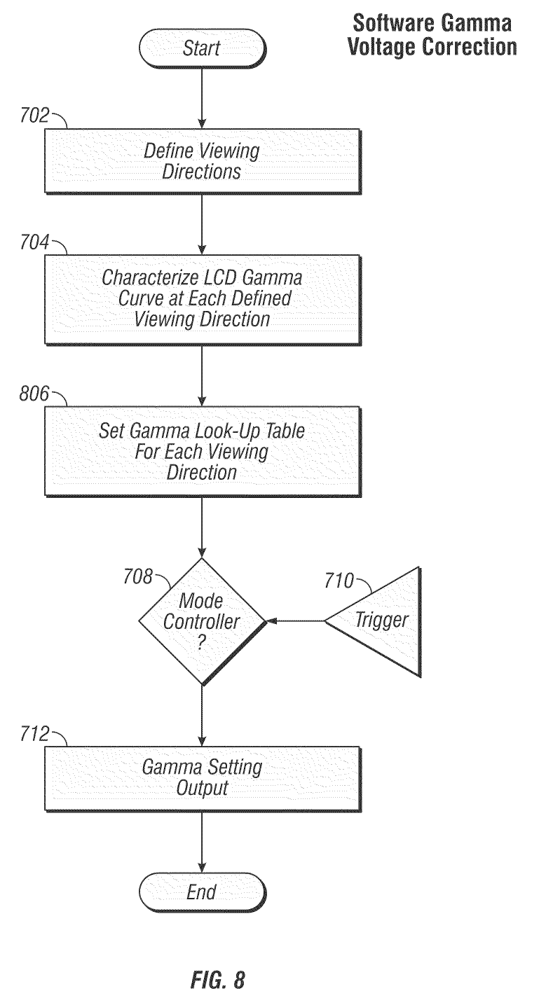

FIG. 8 is a flow diagram illustrating a method of accomplishing gamma voltage correction according to another embodiment of the present invention. As evidenced by the figure, the method is very similar to the method depicted in FIG. 7. However, in step 806, a lookup-table is defined comprising entries corresponding to each viewing direction (or alternatively, to ranges of viewing directions). Note that any method of representation or data structure may be used to implement a look-up table according to embodiments of the present invention. Such data structures include without limitation lists, arrays, trees, databases, hash tables, queues and other such structures. Furthermore, the lookup table may be stored in any combination of volatile and/or non-volatile memory devices.

According to some embodiments, one or more input values (e.g., user input and/or sensory data generated by an inclination sensor) reference a set of voltages represented by data stored within the lookup table. The voltage representation is communicated to display parameter optimization logic which drives the voltages according to one or more bit value inputs associated with each pixel of the display (i.e., grayscale and/or color). Note that the display parameter optimization logic may comprise any combination of software, firmware, and/or hardware according to embodiments of the present invention.

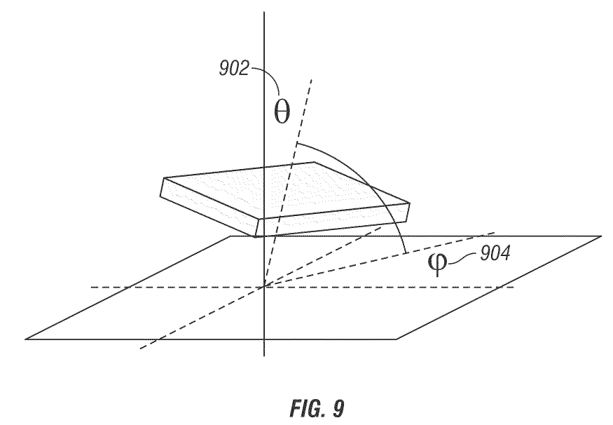

FIG. 9 is an angular representation of a display device orientation according to one embodiment of the present invention. As shown by the figure, the orientation comprises a polar angle θ 902 and an azimuthal angle φ 904. According to the embodiment depicted by FIG. 9, each combination of angles θ 902 and φ 904 references a set of driving voltages optimized for the orientation defined by that particular combination of angles.

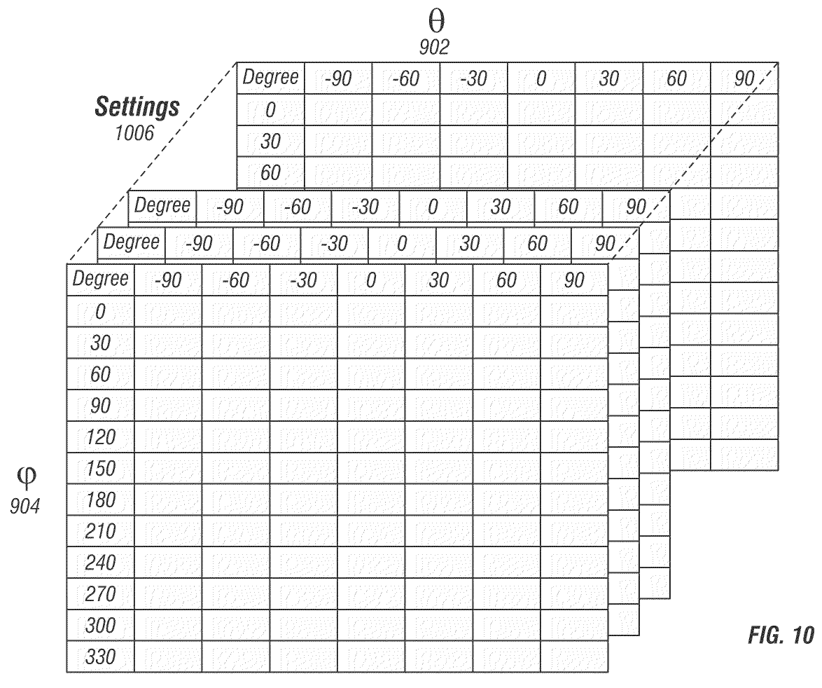

FIG. 10 is a three-dimensional lookup table for use with embodiments employing the angular representation system depicted by FIG. 9. As shown by the figure, polar angles θ 902 are represented horizontally, while azimuthal angles φ 904 are represented vertically. Each table corresponds to one of a plurality of settings 1006. According to some embodiments, the settings 1006 comprise bit values. Thus, the combination of the polar angle θ 902, the azimuthal angle φ, and a bit value references an optimized driving voltage in the three-dimensional table. Note that in some embodiments, if the detected angle combination does not perfectly match with the three-dimensional row and/or column entry, the system will instead use the closest angles listed in the table.

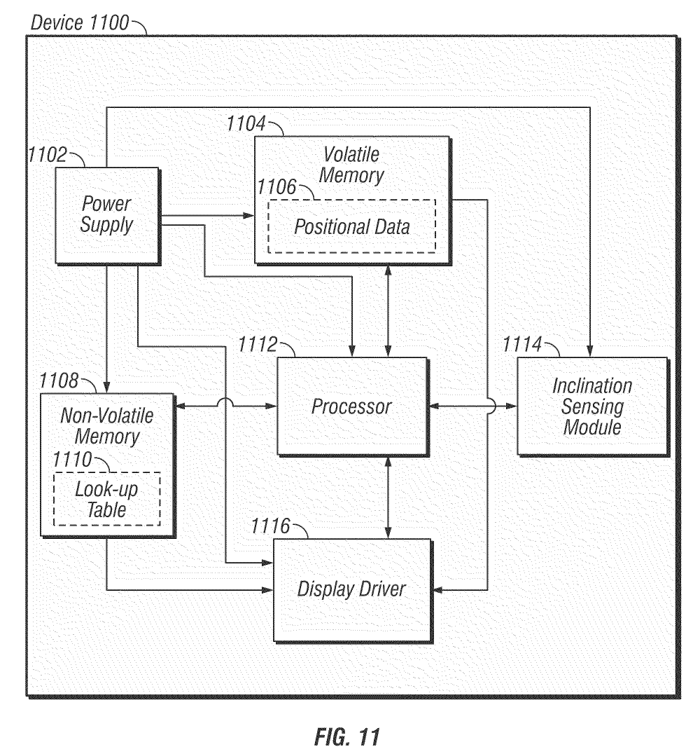

FIG. 11 is a block diagram illustrating a device adapted to present graphical data at designated luminance levels for each of a plurality of display vantage points according to one embodiment of the present invention.

A power supply 1102 provides a source of power to modules housed within the device 1100. In some embodiments, power is supplied externally from one or more conductive wires, for example, as by a power cable or serial bus cable. In other embodiments, a battery may be used as a source of power.

Volatile memory 1104 comprises any type of volatile storage module adapted to enable digital information to be stored, retained, and retrieved. Volatile memory 1104 may include, without limitation, any combination of static and dynamic random access memory. In some embodiments, volatile memory 1104 is adapted to store positional data 1106 associated with an angle of view, user vantage point, or orientation of the device 1100.

Non-volatile memory 1108 comprises any type of non-volatile storage module adapted to enable digital information to be stored, retained, and retrieved. Non-volatile memory 1108 includes, without limitation, programmable read-only memory, erasable programmable read-only memory, electrically erasable programmable read-only memory, and flash memory modules. In some embodiments, non-volatile memory 1108 comprises a lookup table 1110 adapted to store representations of voltage sets that correspond with specific positional data. Note that in some embodiments, all or a portion of the lookup table 1110 may be loaded into volatile memory 1104 during operation.

According to embodiments of the present invention, volatile memory 1104 and non-volatile memory 1108 may be organized in any number of architectural configurations, such as registers, cache memory, data buffers, main memory, mass storage, and/or removable media. Additionally, the amount of memory available can vary between embodiments.

One or more processors 1112 are adapted to execute sequences of instructions by loading and storing data from memory 1104, 1108. Such instructions may include, for example, instructions for data conversions, formatting operations, communication instructions, and/or storage and retrieval operations. Additionally, the processors 1112 may comprise any type of digital processing devices including, for example, digital signal processors, reduced instruction set computers, general-purpose processors, microprocessors, gate arrays, programmable logic devices, reconfigurable compute fabrics, array processors, and application-specific integrated circuits. Note also that the processors 1112 may be contained on a single unitary IC die or distributed across multiple components.

An inclination sensing module 1114 is adapted to detect an orientation of the device 1100 based upon data generated by one or more sensors. In one embodiment, an accelerometer is used for orientation detection, but any device, module, structure, or apparatus capable of detecting orientation or inclination can be used according to embodiments of the present invention. Note also that the inclination may be detected with respect to more than one axis (e.g., inclinations with respect to the x, y, and z axes). In some embodiments, the data recorded by the inclination sensing module comprises positional data 1106 adapted to be stored in volatile memory 1104.

A display driver 1116 is adapted to drive a display associated with the device 1100. In some embodiments, the display driver is adapted to read positional data 1106 and determine an appropriate set of voltages for the display based upon data stored within the lookup table 1110. In other embodiments, the display driver passes data representing a set of voltages to display parameter optimization logic. Once the appropriate voltage set has been selected, an appropriate output voltage per each display pixel is determined according to one or more bit value inputs (i.e. grayscale and/or color values). Output may then be presented at a luminance level optimized for a particular vantage point or angle of view.

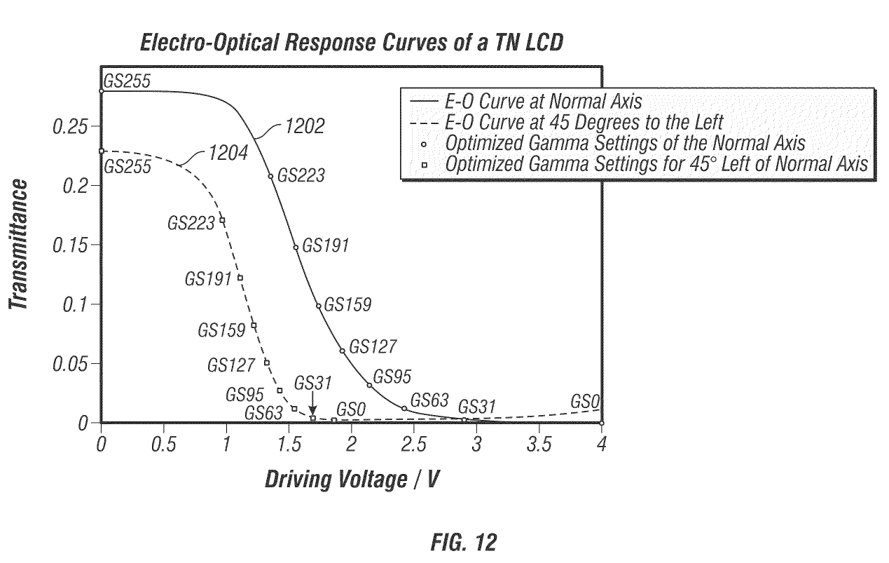

FIG. 12 is a graph illustrating electro-optical response curves optimized for viewing a twisted nematic display at the normal axis and at 45° to the left of the normal axis. Note that the graph depicts an optimization for one particular type of twisted nematic display; in general, optimization curves may vary based on the particular display hardware as well as a variety of other factors.

As seen in the figure, curve 1202 comprises an electro-optical response curve optimized for normal axis viewing, while curve 1204 is optimized for viewing the display at 45° left of the normal axis. A plurality of grayscale values taken from an eight bit range (GS0-GS255) have been plotted along each curve. The gamma voltages are determined based on the electro-optical response curve to satisfy gamma γ=2.2. As shown by the figure, the electro-optical response curves for the two directions could be very different. As a result, different voltage settings are required to achieve the same gamma curve, namely, a first set of display parameters for a perpendicular view, and a second set for a view 45° left of the normal axis.

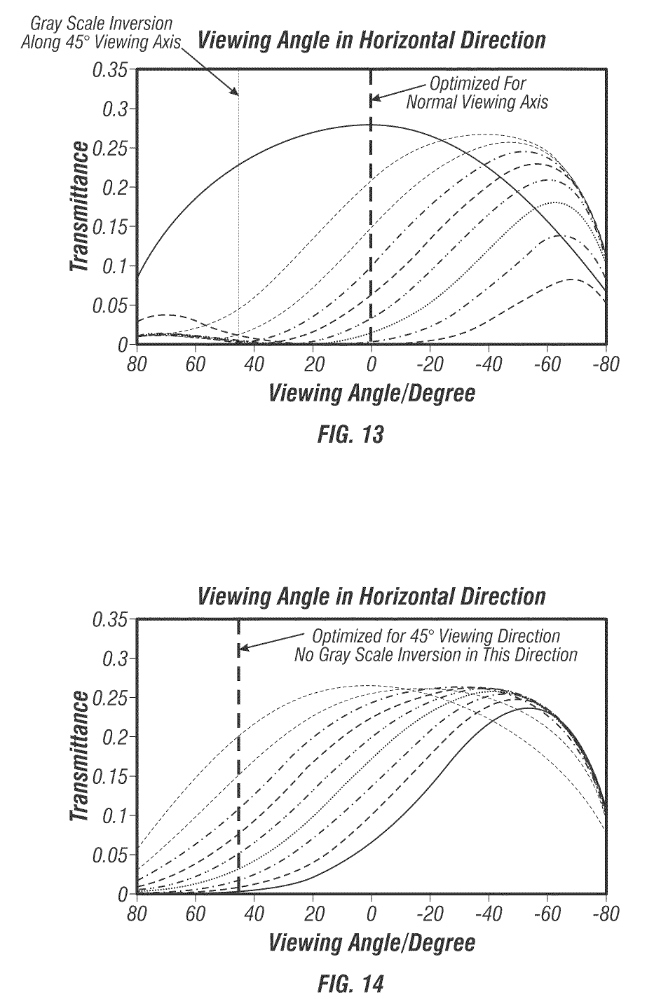

FIG. 13 is a graph illustrating a transmittance curve in a horizontal direction at different gray scale values when the first set of display parameters is used to drive a display. As indicated by the graph, deteriorated images will be perceived in the regions where lines cross over (i.e., gray scale inversion). Note that since gamma is optimized for viewing the display at the normal axis, no gray scale inversion will exist within a certain viewing cone situated around the normal axis. However, dark gray scale inversion still occurs when the image is viewed 45° left of the normal axis.

FIG. 14 is a graph illustrating a transmittance curve in a horizontal direction at different gray scale values when the second set of display parameters is used to drive a display. As can be seen in the figure, performance around the 45° viewing angle improves, and no gray scale inversion is perceptible.

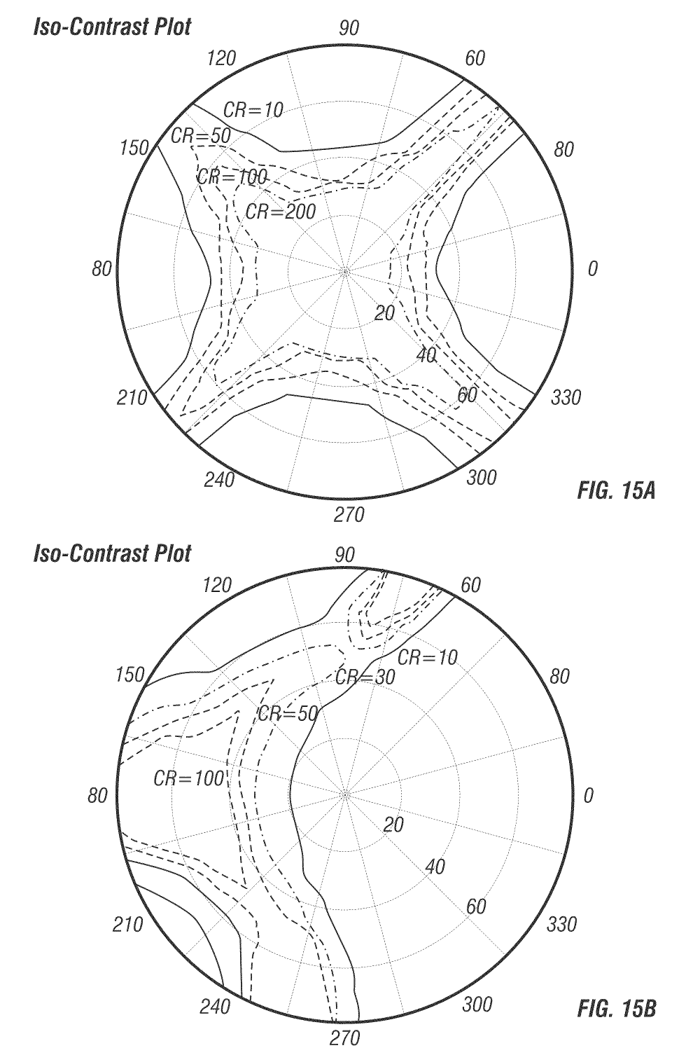

FIG. 15a is an iso-contrast plot of a twisted nematic display operating at the first set of display parameters, while FIG. 15b is an iso-contrast plot of the display operating at the second set of parameters. Both plots depict a map of a 360° viewing cone, where the center point on the map represents a view of the display from the normal axis. The contrast ratio (CR) values depicted in the figures represents ratios of the luminance of the brightest color (white) to that of the darkest color (black) that a display system is capable of producing. A high contrast ratio is generally a desirable quality for a display device.

As shown by FIG. 15a, the center area surrounded by the line marked by “CR=200” has a contrast ratio higher than 200, while the area between “CR=100” and “CR=200” has lower contrast ratio. As shown in FIG. 15b, when the display is optimized for view at 45° left of the normal axis, the contrast ratio boundaries are shifted accordingly.

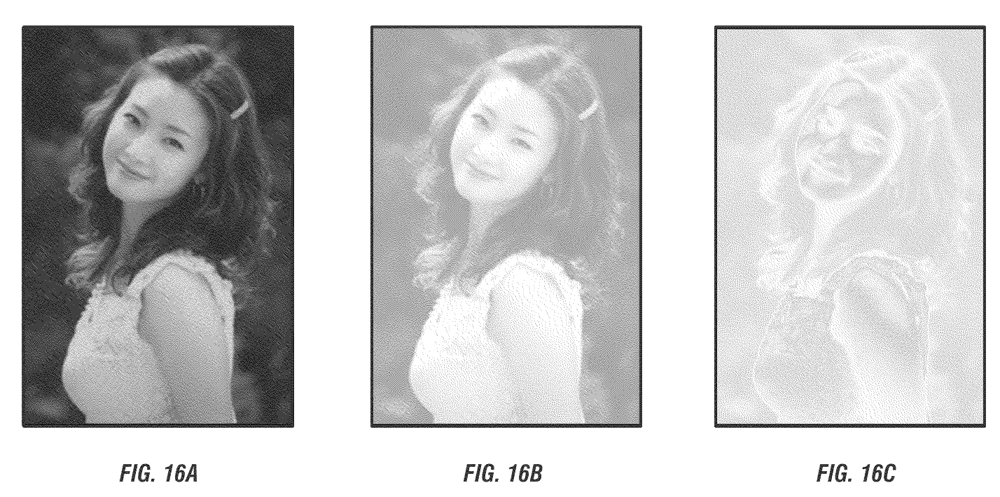

FIGS. 16a-16c are simulations of the appearance of an image presented by a twisted nematic display optimized for view at 45° left of the normal axis. The figures depict how an image may be perceived 45° left of the normal axis of view (FIG. 16a), at the normal axis (FIG. 16b), and 45° right of the normal axis (FIG. 16c). As evidenced by the figures, the luminance for the display is optimized when the image is viewed 45° left of the normal axis.

Although embodiments of this invention have been fully described with reference to the accompanying drawings, it is to be noted that various changes and modifications will become apparent to those skilled in the art. Such changes and modifications are to be understood as being included within the embodiments of this invention as defined by the appended claims.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
determining a plurality of orientation profiles for a display device; and
determining at least one set of parameters adapted to achieve an optimized gamma setting for each orientation profile of the plurality.

2. The method of claim 1, wherein said determining at least one set of parameters comprises mapping grayscale values to driving voltages.

3. The method of claim 2, wherein said mapping grayscale values to driving voltages comprises mapping grayscale values to driving voltages in order to obtain a target luminance function.

4. The method of claim 3, wherein the target luminance function comprises a luminance function that is selectable by a user of the device.

5. The method of claim 2 further comprising detecting the orientation of the device.

6. The method of claim 5, wherein said detecting the orientation of the device comprises detecting the orientation of the device via an inclination sensor.

7. The method of claim 5, wherein said detecting the orientation of the device comprises detecting the orientation of the device via an accelerometer.

8. The method of claim 1, wherein the display device comprises a liquid crystal display.

9. An apparatus comprising:
a first module adapted to determine a set of parameters for obtaining a target gamma setting for each of a plurality of display orientations;
a second module adapted to determine a current display orientation; and
a third module adapted to apply the set of parameters corresponding to the current display orientation.

10. The apparatus of claim 9, wherein the first module is adapted to determine a set of parameters for obtaining a target gamma setting for each of a plurality of display orientations by mapping a set of grayscale values to a set of driving voltages.

11. The apparatus of claim 10, wherein each grayscale value in the set uniquely maps to a driving voltage.

12. The apparatus of claim 9, wherein the first module is further adapted to determine a set of parameters for obtaining a target gamma setting for each of a plurality of display orientations by mapping a set of grayscale values to a set of driving voltages in order to obtain a set of luminance values.

13. The apparatus of claim 12, wherein the set of luminance values is selected based at least in part upon a display orientation and a type of display.

14. The apparatus of claim 13, wherein the type of display is selected from the group consisting of: twisted nematic, super-twisted nematic, and electrically controlled birefringence.

15. The apparatus of claim 9, wherein the second module comprises an inclination sensor.

16. The apparatus of claim 9, wherein the second module comprises an accelerometer.

17. The apparatus of claim 9, wherein the second module comprises a user interface.

18. The apparatus of claim 17, wherein the user interface is adapted to receive a signal from a user for setting a default display parameter.

19. A computer readable medium storing computer executable instructions which, when executed by a computer, perform a process comprising:
receiving positional data associated with a device comprising a display;
determining an optimized display parameter based at least in part upon the positional data; and
driving the display according to the optimized display parameter.

20. The computer readable medium of claim 19, wherein the positional data comprises an amount of device rotation about at least one axis.

21. The computer readable medium of claim 19, wherein the positional data comprises an angle of view.

22. The computer readable medium of claim 19, wherein the positional data comprises at least one coordinate offset.

23. The computer readable medium of claim 19, wherein said determining an optimized display parameter comprises retrieving data from a lookup table.

24. The computer readable medium of claim 19, wherein said determining an optimized display parameter comprises determining a voltage necessary to yield a target luminance from an input grayscale parameter.

25. The computer readable medium of claim 24, wherein the voltage is adapted to drive at least one liquid crystal molecule disposed within the display.

26. A method comprising:
receiving data comprising a bit value and an orientation of a display; and
determining a voltage based at least in part upon the bit value and the orientation of the display.

27. The method of claim 26, wherein the bit value comprises a grayscale value.

28. The method of claim 26, wherein the bit value comprises a color value.

29. The method of claim 26, wherein the voltage is based at least in part upon a target luminance associated with the orientation of the display.

30. The method of claim 29, wherein a function associated with the orientation of the display comprises the target luminance.

31. The method of claim 30, wherein the function comprises a luminance curve that is optimized for viewing the display from an angle.

32. The method of claim 30, wherein the function is based at least in part upon a luminance curve that is optimized for viewing the display from a normal axis.
